(19) United States
(12) Patent Application Publication
(10) Pub. No.: US 2021/0221665 A1
(43) Pub. Date: Jul. 22, 2021

(54) DART COLLECTING DEVICE

(71) Applicant: Kazunori SUZUKI, Aichi (JP)

(72) Inventors: Kazunori SUZUKI, Aichi (JP); Junji SHIMOKAWA, Aichi (JP)

(73) Assignee: Kazunori SUZUKI, Aichi (JP)

(21) Appl. No.: 17/257,113

(22) PCT Filed: Jun. 28, 2019
(86) PCT No.: PCT/JP2019/025794

§ 371 Date: Dec. 30, 2020

(30) Foreign Application Priority Data
Jul. 2, 2018 (JP) 2018-126152

(51) Int. Cl. B66F 15/00; F41J 3/00

(52) U.S. Cl. CPC B66F 15/00; F42B 6/003; F41J 3/0009

(57) ABSTRACT

There is provided a dart collecting device to easily collect darts from a dartboard, even from a relatively low position with respect to the dartboard. The dart collecting device includes: a pair of first gap forming portions that forms a first gap extending in the vertical direction so as to receive a tip of the dart from above at a first interval capable of preventing a barrel of a dart from passing; a pair of second gap forming portions that forms a second gap extending in the vertical direction so as to receive a barrel of a dart from above at a second interval wider than the first interval; a bottom portion that forms a lower end of the second gap; and a shaft that extends downward from the bottom portion. The first gap and the second gap are configured to capable of receiving a dart stuck into a dartboard and capable of stacking and holding a plurality of darts.

### TECHNICAL FIELD

This description discloses a technique relating to a dart collecting device.

### BACKGROUND ART

The darts competition is a type of shooting competition in which darts, hand-throwing arrows, are thrown at a certain distance from a dartboard which is a circular target, and the points are scored according to the position where the darts are stuck into the dartboard. The official rules for darts competition stipulate that the height from the center of the dartboard to the floor is 1730 mm. The dart includes, from the direction of the arrowhead, a tip (also called a “point”) that is the arrowhead, a barrel that is connected to the tip, a shaft that is connected to the barrel, and a flight that is an arrow feather provided on the shaft (See, for example, Patent Document 1). Basically, in a darts competition, for each throwing three darts, a player collects the darts stuck into the dartboard by pulling them out with the player's own hand.

### CITATION LIST

### Patent Literature

[Patent Document 1] JPA2005-152424

### SUMMARY OF INVENTION

### Technical Problem

For a player in a wheelchair, for a relatively short player (for example women, child and so on), and for a player who has difficulty reaching the player's own hands to a dartboard installed at relatively high position, there was a problem that it was difficult to collect darts from the dartboard.

### Solution to Problem

The technique disclosed in the description can be realized in the following aspects.

(1) A dart collecting device in one aspect disclosed in the description is a dart collecting device for collection a dart from a dartboard. This dart collecting device includes: a pair of first gap forming portions that forms a first gap extending in the vertical direction so as to receive a tip of the dart from above at a first interval capable of preventing a barrel of the dart from passing; a pair of second gap forming portions that forms a second gap extending in the vertical direction so as to receive the barrel of the dart from above at a second interval wider than the first interval; a bottom portion that forms a lower end of the second gap; and a shaft that extends downward from the bottom portion, wherein the first gap and the second gap are configured to capable of receiving a dart stuck into a dartboard and capable of stacking and holding a plurality of darts. According to this aspect of the dart collecting device, a plurality of darts can be easily collectively collected from the dartboard even from a position relatively low with respect to the dartboard.

(2) In the dart collecting device of the above aspect, the bottom portion may be inclined toward the first gap. According to this aspect of the dart collecting device, the dart held in the first gap and the second gap can be guided by gravity in the direction in which the barrel of the dart engages with the first gap, so that the dart can be prevented from falling off of the first gap and the second gap.

(3) In the dart collecting device of the above aspect, the dart collecting device may further comprise a pair of third gap forming portions that forms a third gap expanding upward from an upper end of the first gap. According to this aspect of the dart collecting device, the tip of the dart stuck into the dartboard can be easily guided to the first gap through the third gap.

(4) In the dart collecting device of the above aspect, the shaft may extend downward from the bottom portion and rearward from the first gap toward the second gap. According to this aspect of the dart collecting device, it can be easily aligned with the dart stuck into the dartboard. Furthermore, a force for pulling out the dart from the dartboard can be easily applied.

(5) In the dart collecting device of the above aspect, the dart collecting device may further comprise an arm support that provided on the shaft and configured to support an arm of a user. According to this aspect of the dart collecting device, since the user's arm is supported by the arm support, stability and operability can be improved.

(6) In the dart collecting device of the above aspect, the dart collecting device may further comprise: a holder in which the pair of first gap forming portions and the pair of second gap forming portions are formed; a rotary support portion that supports the holder with respect to the shaft so that the holder is capable of rotating rearward from the first gap toward the second gap with respect to the shaft; and a spring portion that pushes the holder forward from the second gap toward the first gap. According to this aspect of the dart collecting device, since the positional deviation in the front-rear direction with respect to the dartboard can be adjusted by rotating the holder with respect to the shaft, the dart stuck into the dartboard can be easily aligned.

(7) In the dart collecting device of the above aspect, the dart collecting device may further comprise a pair of cushioning materials that projects inward and extends in vertical direction in the second gap. According to this aspect of the dart collecting device, by sandwiching at least a part of the barrel and shaft of the dart between the pair of cushioning materials, it is possible to prevent the dart from falling out from the first gap and the second gap.

The techniques disclosed herein can be realized in various aspects different from the dart collecting device. The technique disclosed herein can be realized in aspects of, for example, a part of a dart tool, a method of manufacturing a dart tool, a method of collecting darts and so on.

### BRIEF DESCRIPTION OF DRAWINGS

FIG. 1 is an explanatory drawing which shows the structure of a dart collecting device.

FIG. 2 is an explanatory drawing which shows the detailed structure of the dart collecting device.

FIG. 3 is an explanatory drawing which shows the state of using the dart collecting device.

FIG. 4 is an explanatory drawing which shows the state of using the dart collecting device.

FIG. 5 is an explanatory drawing which shows the state of using the dart collecting device.

FIG. 6 is an explanatory drawing which shows the state of using the dart collecting device.

FIG. 7 is an explanatory drawing which shows a dart collecting device in the second embodiment.

FIG. 8 is an explanatory drawing which shows a dart collecting device in the third embodiment.

FIG. 9 is an explanatory drawing which shows a dart collecting device in the fourth embodiment.

### DESCRIPTION OF EMBODIMENTS

### A. First Embodiment

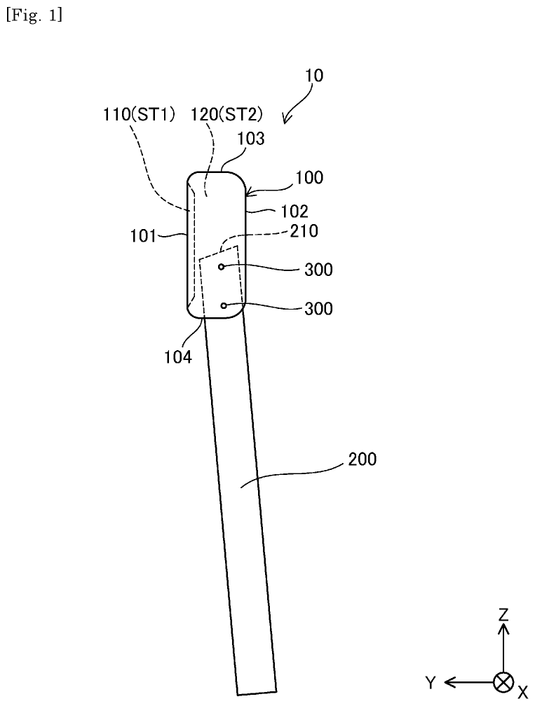

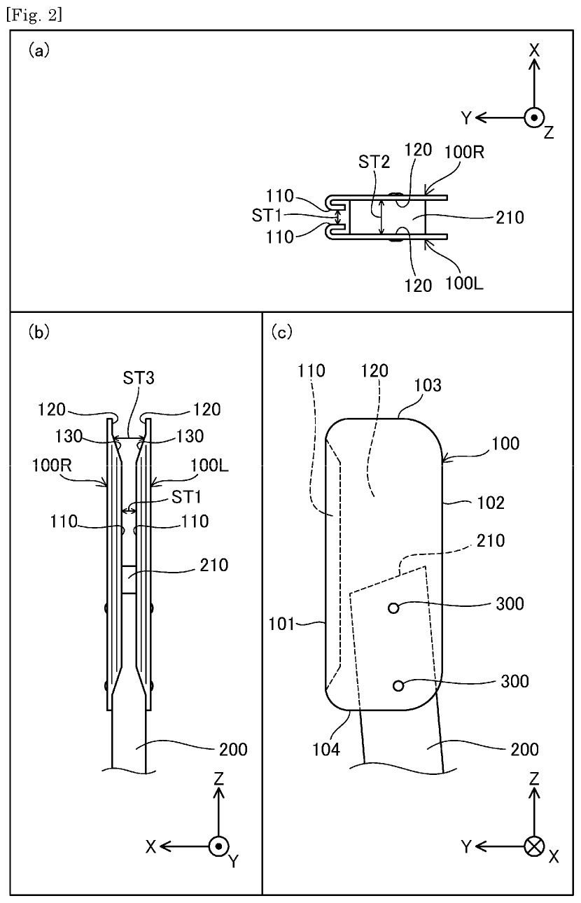

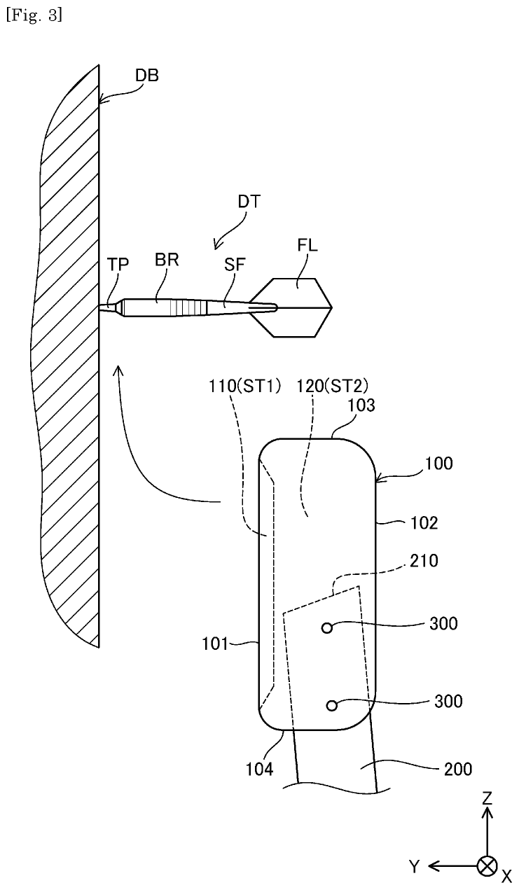

FIG. 1 is an explanatory drawing which shows the structure of a dart collecting device 10. FIG. 2 is an explanatory drawing which shows the detailed structure of the dart collecting device 10. FIG. 2A is a top view showing the detailed structure of the dart collecting device 10 as viewed from above. FIG. 2B is a front view showing a detailed structure of the dart collecting device 10 as viewed from the front. FIG. 2C is a left side view showing a detailed structure of the dart collecting device 10 as viewed from the left side. FIG. 3 is an explanatory drawing which shows the state of using the dart collecting device 10.

The XYZ axes in each figure indicate the positional relationship of each part of the dart collecting device 10. The XYZ axes in each figure correspond to the XYZ axes in the other figures. The +X-axis direction indicates the right side direction, and the −X-axis direction indicates the left side direction. The +Y-axis direction indicates the front direction, and the −Y-axis direction indicates the rear direction. The +Z-axis direction indicates upward, and the −Z-axis direction indicates downward.

The dart collecting device 10 is a device for collecting a dart DT from the dartboard DB. The dart DT includes, from the direction of the arrowhead, a tip TP which is the arrowhead, a barrel BR connected to the tip TP, a shaft SF connected to the barrel BR, and a flight FL which is an arrow feather provided on the shaft SF. The dart collecting device 10 includes a pair of first gap forming portions 110, a pair of second gap forming portions 120, a bottom portion 210, and a shaft 200.

The pair of first gap forming portions 110 in the dart collecting device 10 forms a first gap ST1 having a first interval capable of blocking the passage of the barrel BR of the dart DT. The first gap ST1 extends vertically from above to receive the tip TP of the dart DT. The first gap ST1 is configured to receive the dart DT stuck into the dartboard DB. The first gap ST1 is configured so that a plurality of darts DT can be stacked and held.

The pair of second gap forming portions 120 in the dart collecting device 10 forms a second gap ST2 having a second interval wider than the first interval. The second gap ST2 extends vertically from above to receive the barrel BR of the dart DT. The second gap ST2 is configured to receive the dart DT stuck into the dartboard DB. The second gap ST2 is configured so that a plurality of darts DT can be stacked and held.

In this embodiment, the dart collecting device 10 includes a holder 100 in which the pair of first gap forming portions 110 and the pair of second gap forming portions 120 are formed. The holder 100 has a front end portion 101 facing forward, a rear end portion 102 facing rearward, an upper end portion 103 facing upward, and a lower end portion 104 facing downward. The holder 100 includes a right side plate 100R and a left side plate 100L. The right side plate 100R and the left side plate 100L are metal plates having a rectangular shape in which the portion forming the first gap forming portion 110 is bent inward. The right side plate 100R and the left side plate 100L are fixed to the shaft 200 in a state of sandwiching the bottom portion 210 which is the end portion of the shaft 200. The right side plate 100R and the left side plate 100L are fixed to the shaft 200 by rivets 300. The pair of first gap forming portions 110 and the pair of second gap forming portions 120 are formed by the right side plate 100R and the left side plate 100L facing each other.

In this embodiment, as shown in FIG. 2B, the dart collecting device 10 includes a pair of third gap forming portions 130. The pair of third gap forming portions 130 forms a third gap ST3 which expands upward from the upper end of the first gap ST1. The pair of third gap forming portions 130 is formed by the right side plate 100R and the left side plate 100L facing each other.

The bottom portion 210 of the dart collecting device 10 forms the lower end of the second gap ST2. In this embodiment, the bottom portion 210 is inclined toward the first gap ST1. In other words, the bottom portion 210 faces forward and upward. In this embodiment, the bottom portion 210 is the end of the shaft 200.

The shaft 200 of the dart collecting device 10 extends downward from the bottom portion 210. The shaft 200 is configured so that the user can hold it by the user's hand. In this embodiment, the shaft 200 extends below and behind the bottom portion 210. In this embodiment, the handle 200 is a wooden square timber.

As shown in FIG. 3, when collecting the dart DT from the dartboard DB, the user of the dart collecting device 10 makes the front end portion 101 of the holder 100 run along the dartboard DB from below the dart DT stuck into the dartboard DB, so as to align the first gap ST1 with the tip TP of the dart DT and align the second gap ST2 with the barrel BR of the dart DT.

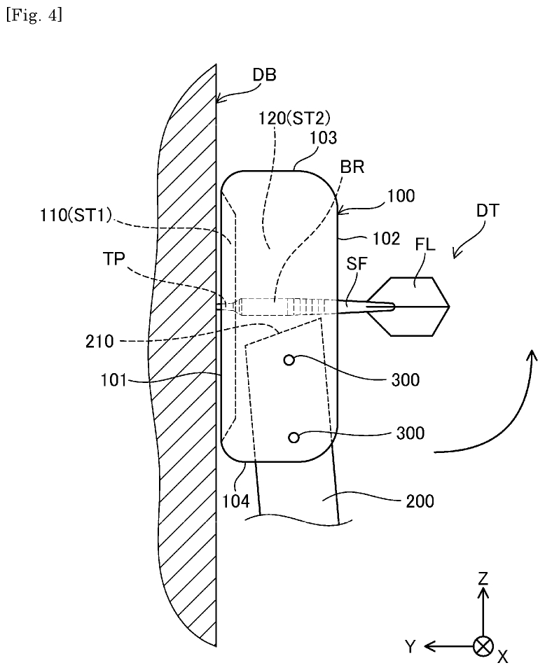

FIG. 4 is an explanatory drawing which shows the state of using the dart collecting device 10. The state of FIG. 4 is a state in which the dart DT is received deep into the first gap ST1 and the second gap ST2 by moving the holder 100 upward from the state of FIG. 3. The user lifts the shaft 200 upward with the upper portion of the front end portion 101 as a fulcrum from the state shown in FIG. 4, so that the contact point between the first gap ST1 and the dart DT or the contact point between the bottom portion 210 and the dart DT becomes a point of action, and the dart DT can be pulled out from the dartboard DB.

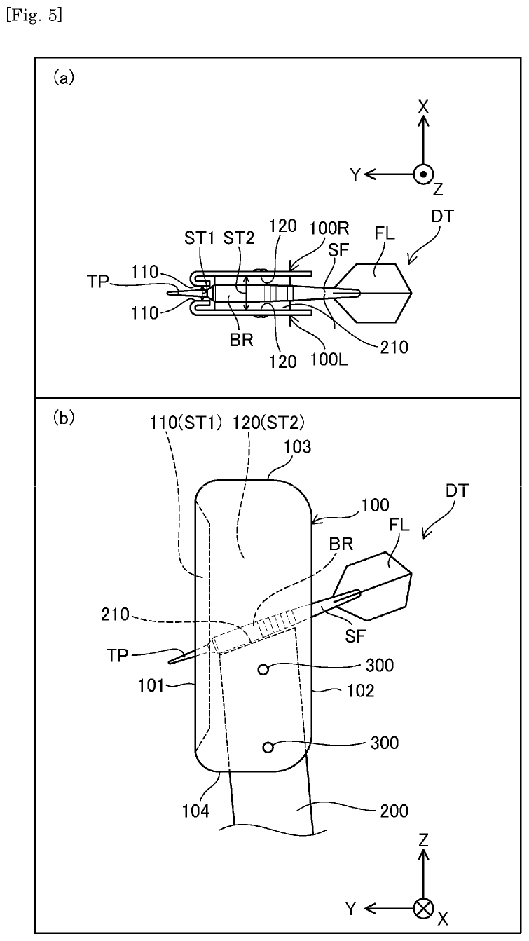

FIG. 5 is an explanatory drawing which shows the state of using the dart collecting device 10. The state of FIG. 5 is a state in which one dart DT is held in the first gap ST1 and the second gap ST2. Since the bottom portion 210 is inclined forward, the dart DT is held by the holder 100 in a state of being inclined forward.

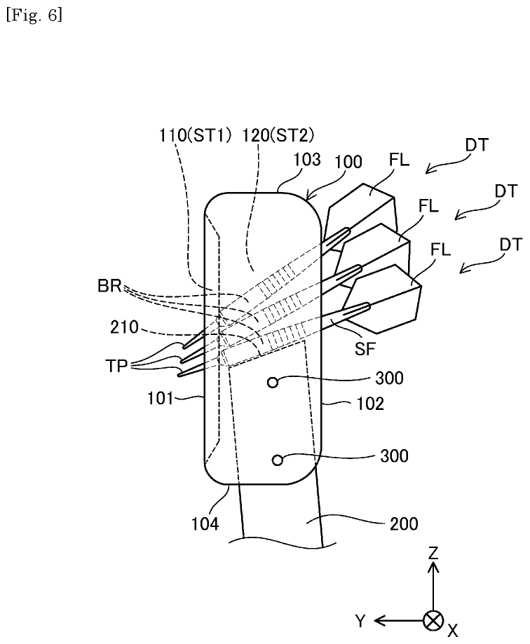

FIG. 6 is an explanatory drawing which shows the state of using the dart collecting device 10. The state of FIG. 6 is a state in which three darts DT are held in the first gap ST1 and the second gap ST2. The user repeats the same operation as in FIG. 3 and FIG. 4 for the second and third darts DT by using the dart collecting device 10 in the state of holding one dart DT (FIG. 5), so that three darts DT can be continuously collected.

According to the first embodiment described above, the first gap ST1 and the second gap ST2 are configured to receive the dart DT stuck into the dartboard DB, and a plurality of darts DT are stacked and held, so that a plurality of darts DT can be easily collectively collected from the dartboard DB even from a position relatively low with respect to the dartboard DB.

Furthermore, since the bottom portion 210 is inclined toward the first gap ST1, the dart DT held in the first gap ST1 and the second gap ST2 can be guided by gravity in the direction in which the barrel BR of the dart DT engages with the first gap ST1, so that the dart DT can be prevented from falling off of the first gap ST1 and the second gap ST2.

Furthermore, since a pair of third gap forming portions 130 forms a third gap ST3 that expands from the upper end of the first gap ST1 upward, the tip TP of the dart DT stuck into the dartboard DB can be easily guided to the first gap ST1 through the third gap ST3.

Furthermore, since the shaft 200 extends downward and rearward from the bottom portion 210, it can be easily aligned with the dart DT stuck into the dartboard DB. Furthermore, a force for pulling out the dart DT from the dartboard DB can be easily applied.

### B. Second Embodiment

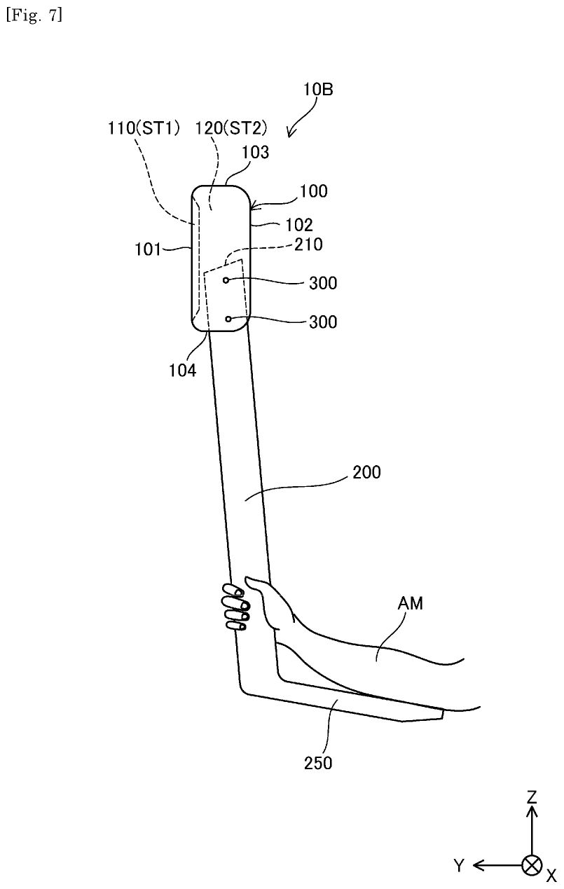

FIG. 7 is an explanatory drawing which shows a dart collecting device 10B in the second embodiment. The dart collecting device 10B of the second embodiment is the same as the dart collecting device 10 of the first embodiment except that it includes an arm support portion 250 configured to support an arm AM of the user. The arm support portion 250 has a shape extending rearward from the lower end of the shaft 200. The arm support portion 250 contacts with the user's arm AM while the user holds the shaft 200.

According to the second embodiment described above, as in the first embodiment, a plurality of darts DT can be easily collectively collected from the dartboard DB even from a position relatively low with respect to the dartboard DB. Furthermore, since the arm AM of the user is supported by the arm support portion 250, stability and operability can be improved.

### C. Third Embodiment

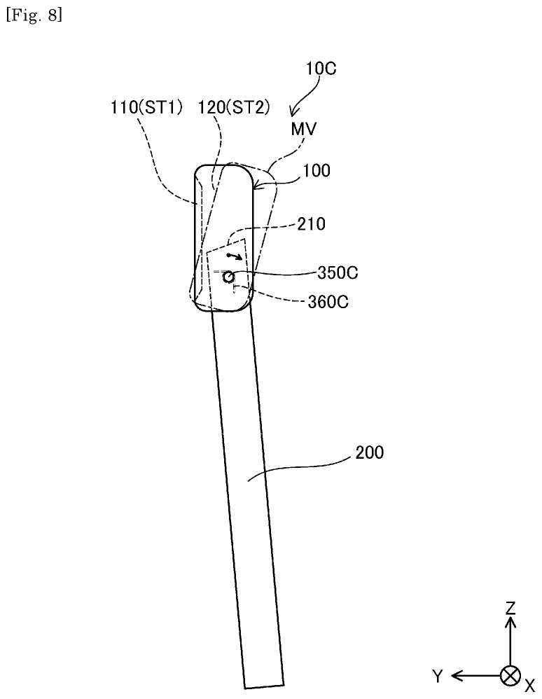

FIG. 8 is an explanatory drawing which shows a dart collecting device 10C in the third embodiment. The dart collecting device 10C of the third embodiment is the same as the dart collecting device 10 of the first embodiment, except that the holder 100 is rotatably supported rearward with respect to the shaft 200. The moving position MV in FIG. 8 indicates the position of the holder 100 which has been rotationally moved backward.

The dart collecting device 10C of the third embodiment includes a rotary support portion 350C and a spring portion 360C instead of the rivets 300. The rotary support portion 350C supports the holder 100 on the shaft 200 so that the holder 100 can rotate rearward with respect to the shaft 200. The spring portion 360C presses the holder 100 forward. In this embodiment, the spring portion 360C includes a metal torsion spring. When the user presses the holder 100 against the dartboard DB, the holder 100 rotates backward toward the moving position MV. When the force for pressing the holder 100 against the dartboard DB is lost, the holder 100 is rotationally moved to the original position by being pressed forward by the spring portion 360C.

According to the third embodiment described above, as in the first embodiment, a plurality of darts DT can be easily collectively collected from the dartboard DB even from a position relatively low with respect to the dartboard DB. Furthermore, since the positional deviation in the front-rear direction with respect to the dartboard DB can be adjusted by rotating the holder 100 with respect to the shaft 200, the dart DT stuck in the dartboard DB can be easily aligned.

### D. Fourth Embodiment

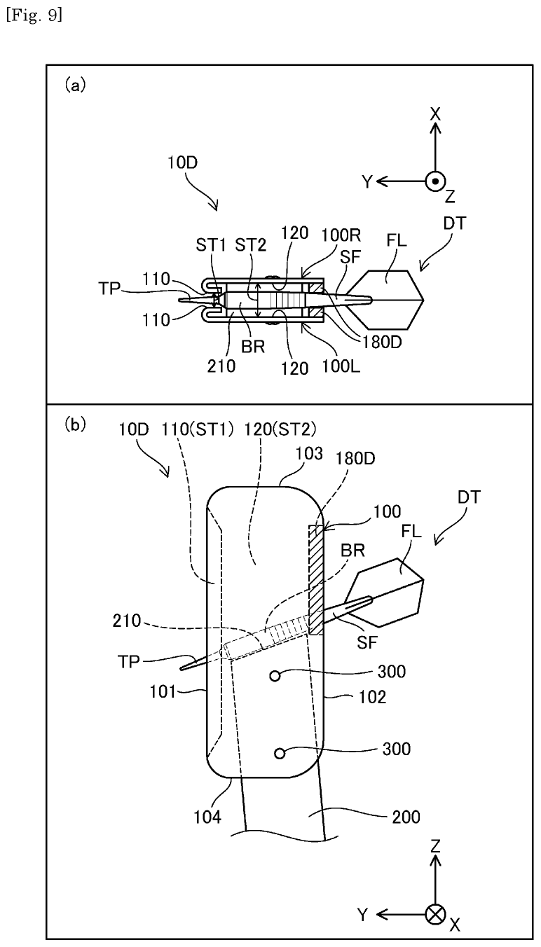

FIG. 9 is an explanatory drawing which shows a dart collecting device 10D in the fourth embodiment. FIG. 9A is a top view showing the dart collecting device 10D seen from above. FIG. 9B is a left side view showing the dart collecting device 10D seen from the left side.

The dart collecting device 10D of the fourth embodiment is the same as the dart collecting device 10 of the first embodiment except that it includes a pair of cushioning materials 180D. The pair of cushioning materials 180D project inward and extend in the vertical direction in the second gap ST2. The pair of cushioning materials 180D in FIG. 9 are hatched. In the present embodiment, the pair of cushioning materials 180D are foamed resin (sponge). The pair of cushioning materials 180D are provided at the rear end portion in the second gap ST2.

According to the fourth embodiment described above, as in the first embodiment, a plurality of darts DT can be easily collectively collected from the dartboard DB even from a position relatively low with respect to the dartboard DB. Furthermore, by sandwiching at least a part of the barrel BR and the shaft SF of the dart DT between the pair of cushioning materials 180D, it is possible to prevent the dart DT from falling out from the first gap ST1 and the second gap ST2.

### E. Other Embodiments

The technique disclosed in this description is not limited to the above-described embodiments, examples and modifications, and can be realized by various configurations without departing from the spirit thereof. For example, among the technical features in the above-described embodiments, examples and modifications, those corresponding to the technical features in each embodiment described in the column of the outline of the invention solve some or all of the above-mentioned problems. It can be replaced and combined as appropriate to, or to achieve some or all of the above effects. In addition, technical features not described as essential in this description may be deleted as appropriate.

The material of the holder 100 is not limited to metal, but may be resin or composite material. The material of the shaft 200 is not limited to wood, and may be resin, metal, or composite material. The holder 100 and the shaft 200 may be an integrally molded product.

The shaft 200 may be provided with a telescopic mechanism. The shaft 200 may be provided with a grip having a shape corresponding to a human hand.

The dart collecting device 10 may include a mechanism capable of adjusting the first interval in the first gap ST1. The dart collecting device 10 may include a mechanism capable of adjusting the second interval in the second gap ST2. The dart collecting device 10 may include a mechanism capable of adjusting the length in the front-rear direction in the second gap ST2.

The dart collecting device 10 may be provided with a magnet which can be attracted to the barrel BR of the dart DT at the lower end of the shaft 200. As a result, when the barrel BR of the dart DT is material which can be attracted to the magnet, the dart DT fallen on the floor can be easily recovered.

The dart collecting device 10 may be provided with a clip at the lower end of the shaft 200 so that the barrel BR of the dart DT can be detachably sandwiched. As a result, the dart DT fallen on the floor can be easily recovered. Furthermore, adhesive material which can be attached to the barrel BR of the dart DT may be provided at the lower end of the shaft 200. As a result, the dart DT fallen on the floor can be easily recovered.

The dart collecting device 10 is provided with a sheet-shaped cushioning material (for example, resin, rubber, foam resin, foam rubber, etc.) on at least one of the surface forming the second gap ST2 and the surface forming the bottom portion 210. As a result, the dart DT can be prevented from damage.

The first gap forming portion 110 may be formed of the same member as the second gap forming portion 120, or may be formed of another member. The second gap forming portion 120 may be formed of the same member as the third gap forming portion 130, or may be formed of another member.

The dart collecting device 10 may be optimized for a shape capable of collecting a dart DT having a resin tip TP (so-called “a soft dart”), may be optimized for a shape capable of collecting a dart DT having a metal tip TP (so-called “a hard dart”), or may be optimized for a shape capable of collecting both a soft dart and a hard dart.

The connecting structure of the holder 100 and the shaft 200 is not limited to the rivet 300, and may be a nail, a screw, a bolt and a nut, or an adhesive.

### REFERENCE SIGNS LIST

10 . . . Dart collecting device
10B . . . Dart collecting device
10C . . . Dart collecting device
10D . . . Dart collecting device
100 . . . Holder
100L . . . Left side plate
100R . . . Right side plate
101 . . . Front end portion
102 . . . Rear end portion
103 . . . Upper end portion
104 . . . Lower end portion
110 . . . First gap forming portion
120 . . . Second gap forming portion
130 . . . Third gap forming portion
180D . . . Cushioning material
200 . . . Shaft
210 . . . Bottom portion
250 . . . Arm support
300 . . . Rivet
350C . . . Rotary support portion
360C . . . Spring portion
AM . . . Arm
BR . . . Barrel
DB . . . Dartboard
DT . . . Dart
FL . . . Flight
MV . . . Moving position
SF . . . Shaft
ST1 . . . First gap
ST2 . . . Second gap
ST3 . . . Third gap
TP . . . Tip

1. A dart collecting apparatus for collecting a dart from a dartboard, the dart collecting apparatus comprising:
a pair of first gap forming portions that forms a first gap extending in the vertical direction so as to receive a tip of the dart from above at a first interval capable of preventing a barrel of the dart from passing;
a pair of second gap forming portions that forms a second gap extending in the vertical direction so as to receive the barrel of the dart from above at a second interval wider than the first interval;
a bottom portion that forms a lower end of the second gap; and
a shaft that extends downward from the bottom portion,
wherein the first gap and the second gap are configured to capable of receiving a dart stuck into a dartboard and capable of stacking and holding a plurality of darts.

2. A dart collecting apparatus according to claim 1, wherein the bottom portion is inclined toward the first gap.

3. A dart collecting apparatus according to claim 1, further comprising a pair of third gap forming portions that forms a third gap expanding upward from an upper end of the first gap.

4. A dart collecting apparatus according to claim 1, wherein the shaft extends downward from the bottom portion and rearward from the first gap toward the second gap.

5. A dart collecting apparatus according to claim 1, further comprising an arm support that provided on the shaft and configured to support an arm of a user.

6. A dart collecting apparatus according to claim 1, further comprising:
a holder in which the pair of first gap forming portions and the pair of second gap forming portions are formed;
a rotary support portion that supports the holder with respect to the shaft so that the holder is capable of rotating rearward from the first gap toward the second gap with respect to the shaft; and
a spring portion that pushes the holder forward from the second gap toward the first gap.

7. A dart collecting apparatus according to claim 1, further comprising a pair of cushioning materials that projects inward and extends in vertical direction in the second gap.
